(19) United States
(12) Patent Application Publication
(10) Pub. No.: US 2009/0262416 A1
(43) Pub. Date: Oct. 22, 2009

(54) CASCADE LASER

(75) Inventors: David George Lancaster, Klemzig (AU); Shayne Peter Bennetts, Forestville (AU)

Correspondence Address: GRAYBEAL JACKSON LLP, 155 - 108TH AVENUE NE, SUITE 350, BELLEVUE, WA, 98004-5973, US

(73) Assignee: The Commonwealth of Australia, Canberra (AU)

(21) Appl. No.: 12/426,128

(22) Filed: Apr. 17, 2009

Related U.S. Application Data
(63) Continuation-in-part of application No. PCT/AU2007/001597, filed on Oct. 18, 2007.

(30) Foreign Application Priority Data
Oct. 18, 2006 (AU) 2006905778

(51) Int. Cl. H01S 3/30; H01S 3/00; G02B 6/036

(52) U.S. Cl. 359/341.1; 372/6; 385/127

(57) ABSTRACT

Disclosed is an optical fiber that includes an inner core having a concentration of at least one laser active material, the inner core being adapted to operate in a single mode manner; and an outer core disposed about the inner core having a concentration of at least one laser active material. The outer core being adapted to operate in a multimode manner, a cladding disposed about the outer core; and an outer cladding is disposed about the cladding adapted to substantially confine pump light within the cladding.

### PRIORITY CLAIM

The present application is a Continuation-in-Part application of copending International Patent Application Serial No. PCT/AU2007/001597, filed Oct. 18, 2007; which application claims the benefit of Australian Patent Application Serial No. 2006905778, filed Oct. 18, 2006; all of the foregoing applications are incorporated herein by reference in their entireties.

### TECHNICAL FIELD

The present invention relates generally to optically pumped lasers, and particularly but not exclusively to optically pumped waveguide lasers.

### BACKGROUND ART

Fiber lasers or amplifiers comprising a doped fiber core with a laser active material, the core pumped with a single transverse mode pump source such as a diode laser or a Ti:Sapphire laser are known. A problem with this design is that the cost of a single transverse mode pump source per unit of pump power is very high making high power sources based on core pumped fibers impractical. Furthermore lasers and amplifiers constructed this way have a lower spatial brightness than their pump sources.

An improvement on this design was the development of the double clad fiber as shown in FIG. 1. In this design the fiber core 1 is surrounded by an inner cladding 2 which confines the laser light to the core and into which a pump light source can be launched. The cladding is itself surrounded by an outer cladding 3 which confines the pump light to the cladding. Thus the light from each layer is confined by successive outer layers which have a lower effective refractive index or by using bandgap effects.

The trade off with moving from a single clad fiber laser structure to a double clad fiber laser structure is that effective pumping only occurs when the pump light passes through the core and is absorbed. The proportion of time that the pump light spends passing through the core is proportional to the ratio of the core area A_{core} to the area of the cladding A_{cladding} and thus the absorption strength of the cladding a_{cladding} is related to the absorption strength of the core a_{core} by:

$${α}_{cladding} = {α}_{core} \frac{{A}_{core}}{{A}_{cladding}}$$

The maximum absorption of any core is limited. With the use of some ions, such as erbium, high doping causes clustering of the ions which leads to upconversion losses which detract strongly from the efficiencies achievable. As a result ions like erbium (Er) can only be doped in low concentrations. This is overcome in practice by co-doping with Yb to increase the absorption and relying on ion-ion energy transfer to transfer energy to the Er ions. Other ions such as Ytterbium (Yb³⁺) and Thulium (Tm³⁺) can be doped much more heavily without clustering, indeed Thulium performs best at high concentrations but whatever you do there is a limit to how heavily you can dope glass with a rare earth ion, this puts an upper limit on the absorption strength of any core.

The core size of a laser is restricted by the need to maintain good beam quality. This is normally done by choosing a core which will only confine the lowest transverse mode or by choosing a core which will only confine a few low order modes and then using techniques such as bend loss to filter out all but the lowest order mode. A fiber core has a V parameter given by:

$$V = 2 π \frac{aNA}{λ}$$

where NA is the numerical aperture of the fiber (related to the index difference), λ is the lasing wavelength and a is the core radius. The core will be single spatial mode if it has a V parameter less than 2.4. Bend loss is effective in maintaining single mode operation in cores with a V number up to about 4 and has been demonstrated in cores with a V number as high as 7 with tight bend radii.

The tensile strength of materials used to construct fibers limits the bend radius which can be used for large diameter fibers. A solution which allows cores with larger V parameters than 2.4 to be used without the need to tightly bend fibers involves the use of a helical core where the core bends with a radius sufficient to filter out higher order modes.

The minimum length of fiber required to efficiently absorb pump is limited by the core to cladding area ratio and the maximum core absorption. Furthermore the core diameter is limited by the need to maintain single mode operation thus limiting the minimum fiber length which is necessary for a given cladding diameter.

The performance of high power fiber lasers and amplifiers is often limited by nonlinear effects in the fiber core such as stimulated Brillouin scattering. The threshold for nonlinear effects is inversely proportional to the fiber length. For this reason the fiber length used should be minimized. In addition, fiber cost, background losses and reabsorption loss in 3 level laser systems can all be reduced by decreasing the length of fiber used. Furthermore, for short pulse Q switched lasers it is important to minimize the cavity length since the pulse length obtainable is proportional to the cavity length.

The most available and inexpensive source of high power pump light for pumping lasers is from laser diode bars and from laser diode stacks. These are used to pump high power rod and slab lasers. The typical beam from a diode bar is approximately 9.5 mm wide in the slow axis with a divergence around 7 degrees full width half maximum. This will focus down to a spot approximately 1.35 mm in diameter with an NA around 0.44. This will not couple efficiently into a typical 400 mm fiber and as a result many complex and expensive techniques have been developed to efficiently couple the light from diode bars and stacks into double clad fiber lasers. Although it is possible to make larger diameter fibers the resulting absorption would be low and would therefore require a long gain medium to absorb the pump light efficiently which in turn would give a very low nonlinear threshold dramatically reducing the spectral brightness obtainable from such a fiber.

U.S. Pat. No. 5,291,501 (1994) “Optical fiber with doped core and doped inner cladding, for use in an optical fiber laser” discloses an optical fiber laser which includes an optical fiber having a core, an inner cladding surrounding the core and a single outer cladding surrounding the inner cladding and core. The core is doped with a first laser-active material, disclosed as thulium. The inner cladding is doped with a second different laser-active material, disclosed as neodymium and is pumped by a multimode pump light source such as a diode array. Pumping of the inner cladding causes laser emission in the inner cladding material which, in turn, serves as pump radiation for the laser-active dopant in the core. This is based on a simple double clad geometry. It has the problem that there is little flexibility in changing fiber geometries. The core size is fixed for single transverse mode operation, and the area overlap ratio is fixed by the requirement for the inner cladding to achieve lasing threshold and to efficiently pump the core; thereby restricting the cladding size available to couple in the pump light. This will lead to a requirement for a relatively high brightness pump light source and limit the power scaling potential of the device.

Another problem with this geometry is that if a 3-level lasing ion is used in the inner-cladding, the fiber length would be limited as the less than optimum pumped inner-cladding regions (furthest from the pumped end) will not achieve a population inversion and hence re-absorb lasing light and act as a loss source further restricting the power scaling potential of the device.

### DISCLOSURE OF THE INVENTION

Some embodiments of the present invention have a double clad waveguide laser within a double clad waveguide laser. A low brightness pump light is absorbed by an outer core which produces a high brightness secondary pump light, by way of laser action, which in turn is absorbed by an inner core which in turn emits a high spatial brightness laser beam. A double clad fiber laser acts as a spatial brightness converter. It absorbs low brightness pump light into a core which produces a high brightness output beam. Thus, embodiments facilitate an interactive process which increases the brightness on each iteration. In some embodiments this process may be interacted more than twice by having more than two active regions, for example. Advantageously, this iterative process permits, in some embodiments, the use of otherwise insufficiently bright pump sources to achieve laser action. This technique can be realized in both fiber and planar waveguide geometries, for example.

In a first aspect of the invention, there is provided an optical fiber comprising an inner core light guiding region having a laser active material, said inner core being adapted to operate in a substantially single mode manner; an outer core light guiding region disposed about said inner core having another laser active material, said outer core being adapted to operate in a multimode manner, a cladding light guiding region disposed about said outer core; and an outer cladding is disposed about said cladding light guiding region adapted to substantially confine pump light within said cladding light guiding region.

In an embodiment, the outer cladding has a refractive index lower than that of the cladding, the cladding has a lower refractive index than the outer core region, and the outer core region has a lower refractive index than the inner core region. This ensures that light from each layer is confined within.

Advantageously, some embodiments of the invention increase the optical pump absorption strength of the optical fiber allowing larger cladding diameters to be used or shorter fiber lengths to be used in the construction of a laser or amplifier while not requiring the increase of either the area of the core or the dopant concentration in the core. This can be used to allow cladding diameters sufficiently large that direct pumping of fiber lasers with diode stacks and diode bars while at the same time reducing the length of fiber required for efficient absorption. It will be appreciated that these and other advantages translate seamlessly from fiber embodiments to embodiments having planar geometries

In an embodiment, the fiber has a microstructured design to confine light. The microstructured design may be used to create a bandgap to confine light.

It is known to use a non-circular or non-symmetric cladding shape to improve pump light mixing and improve absorption efficiency within a core. In an embodiment the outer core and cladding shape can be non-circular or non-symmetric although the utility of this invention is not dependent on the shape of the light guiding regions.

In an embodiment of the invention a microstructured fiber design is used to create a bandgap in order to confine light.

It is known to use ring doping and other doping and refractive index profiles to create light guides which confine light with additional advantageous properties such as lower fundamental mode loss [e.g. U.S. Pat. No. 6,614,975]. The utility of this invention is not dependent on the doping profile used to define the light guides within the structure.

In an embodiment, additional regions containing laser active material can be disposed around the outer core and within the cladding.

In an embodiment, the outer cladding is of a diameter sufficient to allow direct coupling of a low brightness diode bar or diode stack pump light source. The outer perimeter of the outer core region may be non-circular.

In an embodiment, the fiber host material is silica glass.

In an embodiment, the fiber host material is a soft glass such as fluoride, telluride or chalcogenide.

In an embodiment, the fiber host material is a polymer.

In an embodiment, each of the laser active materials comprise a rare earth ion such as Tm³⁺, Yb³⁺, Ho³⁺, Er³⁺, Pr³⁺ and Nd³⁺.

In an embodiment, at least one rare earth element in the inner core is a different element from the rare earth element in the outer core.

In an embodiment, at least one rare earth element in the inner core is the same element as the rare earth element in the outer core.

In an embodiment, the laser active material in the inner core is made up of Ho³⁺ ions and the laser active material in the outer core is made up of Tm³⁺ ions.

In an embodiment, the laser active material in the inner core is made up of Tm³⁺ ions and the laser active material in the outer core is made up of Er³⁺:Yb³⁺ codoped ions.

In an embodiment, bragg gratings, resonator mirrors or fiber end face reflections are employed to resonate light within the outer core.

In an embodiment, stress rods can be inserted into the regions or an elliptical core shape can be used to create birefringence in the core and thus preserve the polarization state of light propagating through the core.

In an embodiment, the inner core acts as an amplifier.

In an embodiment, additional core regions can be contained within the structure to further cascade the lasing process.

In an embodiment, the fiber can have a helical core allowing a large mode area for low nonlinearity in a large diameter cladding which otherwise couldn't be bent.

In a second aspect of the invention there is provided an optical apparatus comprising: an inner-core light guiding region having a laser active material, said inner-core being adapted to operate in a substantially single mode manner; an outer-core light guiding region disposed about said inner-core having another laser active material, said outer-core being adapted to operate in a multimode manner; a cladding light guiding region disposed about the outer-core; and an outer-cladding disposed about said cladding light guiding region adapted to substantially confine light within said cladding light guiding region.

In an embodiment, the optical apparatus comprises a planar optical waveguide. The apparatus may be the planar waveguide. It will be appreciated that most if not all the fiber laser embodiments described herein have analogous planar optical waveguide embodiments.

In a third aspect of the invention there is provided a method of generating radiation, the method comprising the step of:

coupling a light generated by a cladding pumped laser into a second waveguide in parallel with the cladding pumped laser, the light pumping a laser active material within the second waveguide.

In this specification, in parallel means that:

the light leaving an output end of the first waveguide is not launched into an input end of the second waveguide.

It will be appreciated that in parallel waveguides are analogous to in parallel electronic components. The axes of the first and second waveguides may not necessarily be geometrically parallel. In some embodiments, in parallel means that coupling of the light occurs along a common length of the first and second waveguides.

In an embodiment, the light is laser light.

The first and second waveguides may be arranged in accordance with the second aspect of the invention.

In an embodiment, the step of pumping a laser active material within the second waveguide further comprises generating another light emitted from the second waveguide. The another light may be another laser light.

### BRIEF DESCRIPTION OF THE DRAWINGS

Embodiments will now be described by way of example only with reference to the accompanying drawings in which:

FIG. 1 is a diagram of a cross section of a double clad optical fiber of the prior art.

FIG. 2 is a diagram of a cross section of an optical fiber with a doped core 4, a doped inner cladding 5, and an outer cladding 6 of the prior art.

FIG. 3 is a diagram of a cross section of a fiber which is an embodiment in accordance with one aspect of the present invention.

FIG. 4 shows an example diagrammatic representation of a fiber in accordance with one aspect of the present invention with a source of pump light.

FIG. 5 is a diagram of a cross section of a fiber in accordance with one aspect of the present invention where the inner core and the outer core are doped with the same dopant.

FIGS. 6 to 9 show further embodiments according to aspects of the present invention.

FIG. 10 is a photomicrograph of one embodiment of a fiber.

FIG. 11 is a schematic of one embodiment of a laser.

FIG. 12 shows experimental data from the embodiment of FIG. 11.

FIG. 13 is a cross sectional diagram of an embodiment of an optical waveguide in accordance with an aspect of the invention.

### BEST MODE FOR CARRYING OUT THE INVENTION

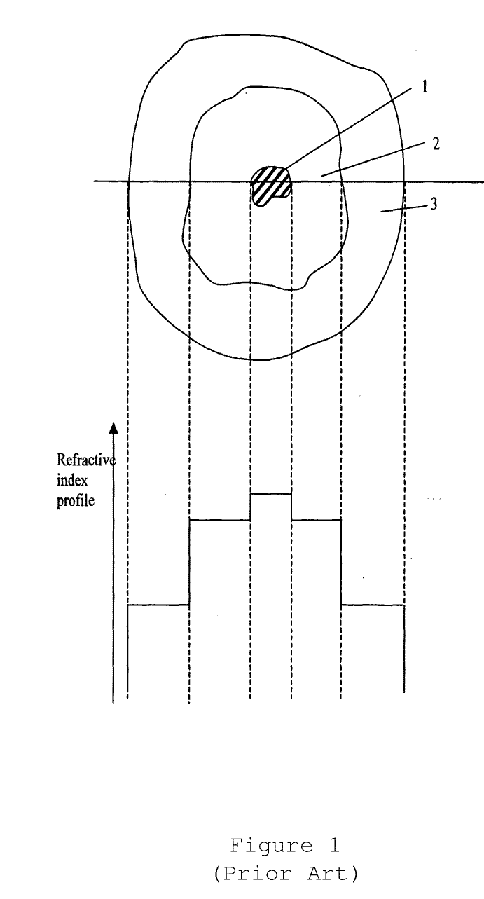

Referring now to the illustrations, FIG. 1 is a diagram of a cross section of a double clad fiber of the prior art.

There is a doped core 1 surrounded by an inner cladding 2 which is further surrounded by an outer cladding 3.

The core is doped with any appropriate rare earth ion or other laser active material in order that it will act as a laser.

The inner cladding receives the pump light, which is retained within the inner cladding by the outer cladding which is of a lower refractive index. The pump light contained within the cladding passes through the core from time to time where it may be absorbed to drive the laser effect.

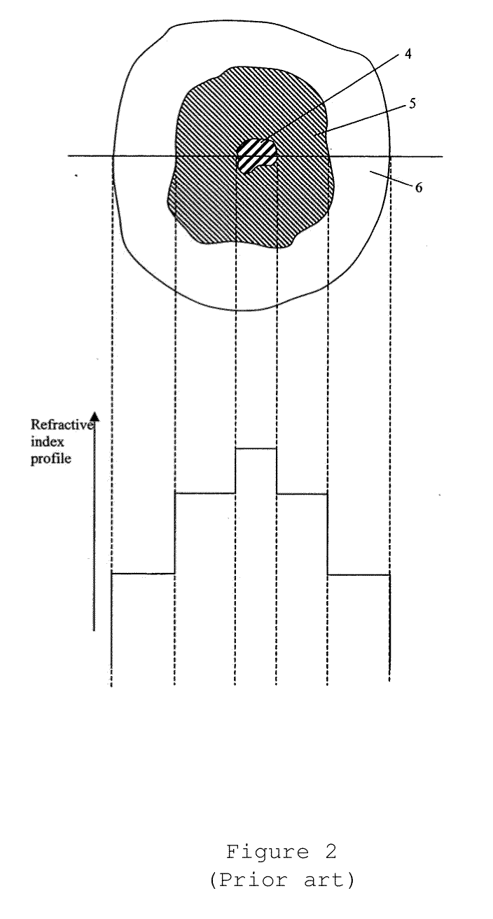

FIG. 2 is a diagram of a cross section of a double clad fiber with a doped inner cladding region.

The optical fiber has an inner cladding 5 doped with neodymium and a monomode core 4 doped with thulium. A suitable outer cladding 6 surrounds the inner cladding 5 and core 4. Pumping of the inner cladding causes laser emission in the inner cladding material which, in turn, serves as pump radiation for the laser-active dopant in the core.

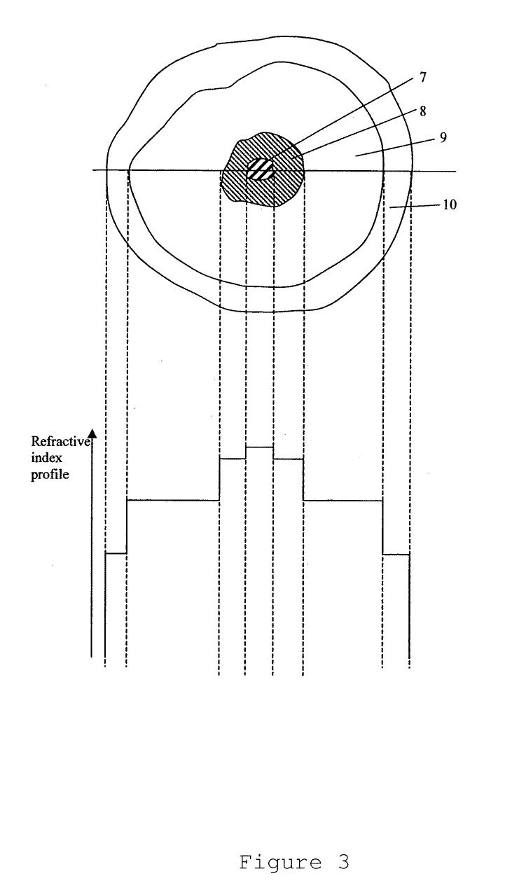

FIG. 3 shows a diagrammatic cross section of a fiber which is an embodiment of the invention.

There is provided an inner core 7 which is surrounded by an outer core 8. This is further surrounded by a cladding 9 and which is further surrounded by an outer cladding 10.

Both the inner core and the outer core are doped with rare earth ions and are thus able to act as lasers, when pump light is applied.

The inner core is of sufficiently small dimension to achieve single mode or few mode operation.

The outer cladding confines the pump light within the cladding. The outer core is of sufficient diameter that both the pump absorption efficiency from the cladding and the inner core absorption efficiency from the outer core for a given fiber length is of an acceptable level.

It can be seen that the operation of the outer core will be multi mode, whilst the operation of the inner core which is the source of the usable laser is single mode.

Since the outer core is multimode the ratio of the area of the outer core to the area of the cladding can be low compared with the 1:400 ratios found in conventional double clad fibers allowing the rapid absorption of the pump light over a short length even when the cladding is made sufficiently large that a diode bar or stack can be directly focused into the cladding.

The cladding 9 may be of sufficiently large diameter that it can be directly coupled to a low cost diode bar as the source of the pump light.

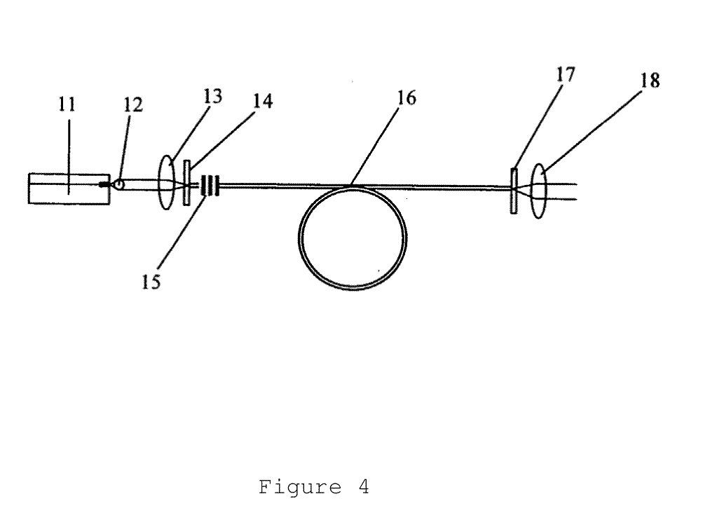

FIG. 4 shows an example diagrammatic representation of a fiber of the invention with a source of pump light. This consists of a diode laser pump source 11, a fast axis pump light collimating optic 12, a pump light focusing optic 13 and a dichroic input coupler which is highly reflective at the lasing wavelength of the outer core (in this example around 1930 nm) and highly transmissive at the diode pump wavelength (in this example 790 nm). The pump light is focused into the inner cladding of an example of a fiber embodiment of the current invention 16 which has a holmium doped inner core and a thulium doped outer core. The fiber can be butted up to the input coupler. Close to the pump end a fiber Bragg grating is written into the core of the fiber 15 which is highly reflective at the required wavelength from the inner core, 2100 nm in this case. It is necessary to be close to the pump end as energy absorbed before the grating in the inner core is lost. If the grating 15 is not reflective near the top of the gain for the inner core it may be necessary to ensure that the dichroic reflector 14 is also highly transmissive at wavelengths where the inner core has high gain. At the other end of the fiber there is an output coupler mirror butt coupled to the fiber 17. This has high reflectivity at the pump wavelength (790 nm) and the lasing wavelength of the outer core (1930 nm) but low reflectivity at the lasing wavelength of the inner core (2100 nm) and other wavelengths in the gain window of the inner and outer cores. A collimating optic 18 can be used to collimate the resultant laser radiation from the inner core.

In further embodiments Bragg gratings or resonator mirrors or a combination of the two are employed to resonate light within the outer core which thus gives very high efficiency coupling of the pump light within the outer core into the inner core.

In a further embodiment the transition between the inner and outer cores may be gradual and ill defined.

In general the doping of the inner and outer cores will be with different rare earth ions. The choice of the ion pairs in the inner and outer cores must be carefully made to ensure that energy from the outer core is absorbed in the inner core. Examples of possible combinations would be a) thulium in the outer core with holmium in the inner core or b) thulium in the inner core and ytterbium in the outer core c) erbium and ytterbium in the outer core and thulium in the inner core d) erbium in the outer core with thulium in the inner core.

In an alternative embodiment the same ion, for example erbium, may be used in both the inner and the outer core.

It is not necessary that lasing should occur in the outer core, it may be possible to use amplified spontaneous emission from the outer core to pump an inner core. In an embodiment this has the advantage of reducing optical loss and reducing the complexity of the optics required to maintain lasing.

In an embodiment the non-lasing of the outer core may be achieved by doping both cores with the same ion but ensuring that the doping level in the outer core is insufficient to support lasing.

Some embodiments of the invention provide a method for designing a laser gain medium which overcomes the limitations of the prior art to allow the construction of an efficient laser or amplifier with a substantially shorter length than is possible using present techniques. This allows for the construction of higher power devices free from nonlinear effects, shorter pulse Q switched fiber lasers, lower cost devices which use less fiber and allow direct focusing of low cost diode bars and stacks and more efficient devices with lower loss and reabsorption.

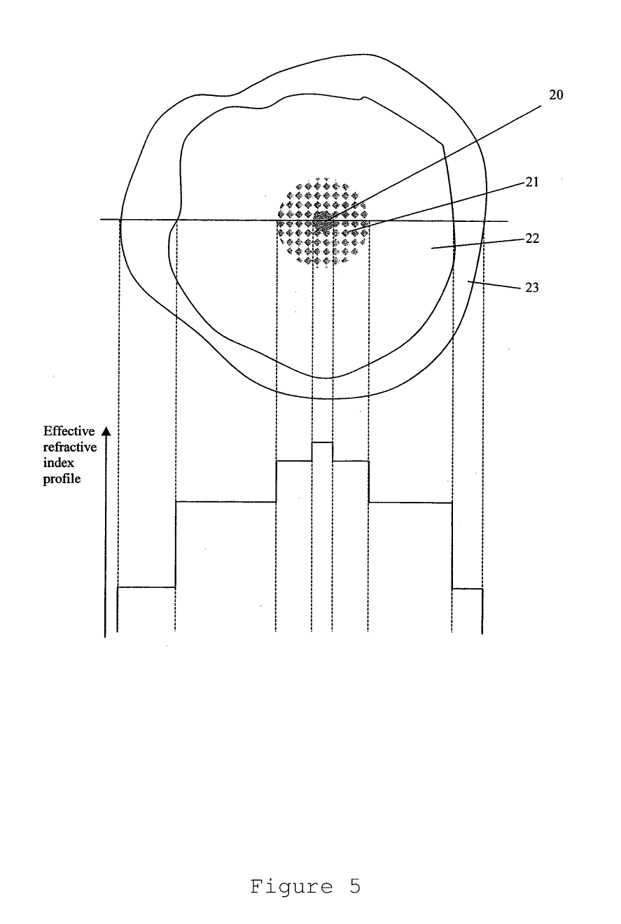

FIG. 5 is a diagram of the cross section of a fiber which is an embodiment of the current invention where the inner core 20 and the outer core 21 are doped with the same dopant and at the same concentration and where a microstructure with air holes is used to define the outer core 21 by reducing the effective refractive index of this region. The effective refractive index of the outer core 21 is higher than the surrounding inner cladding 22 and thus forms a light guiding structure. The inner cladding is surrounded by an outer cladding 23 which contains the pump light.

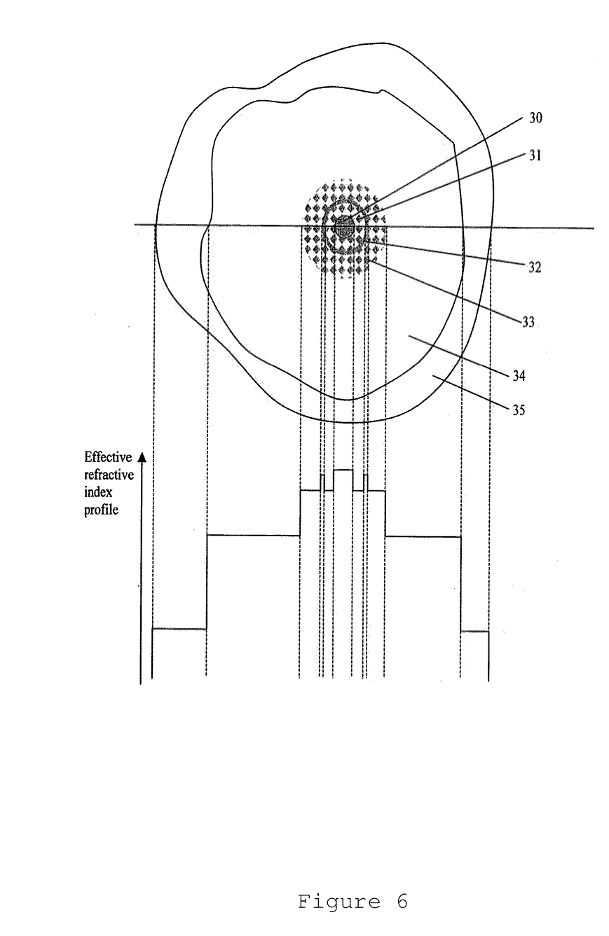

FIG. 6 is a diagram of a cross section of another embodiment of the current invention. Here the few mode inner core is defined by a more complex refractive index and dopant structure. The inner core is defined by a central region with a raised refractive index 30 together with a raised refractive index ring 32. This structure can assist by reducing bend loss for the fundamental mode while allowing high bend loss for higher order modes thus allowing single mode output from a few moded large mode area core. Distributed refractive index profiles defining light guides, including single mode light guides with additional properties and do not change the nature or utility of this invention. The multimode outer core is defined by the microstructure region 31 and 33 with a higher refractive index than the inner cladding 34 and outer cladding 35 but a lower effective refractive index than the core 30/32. It should of course be clear that the light in the outer core also passes through the inner core although it is not confined by the structure of the inner core.

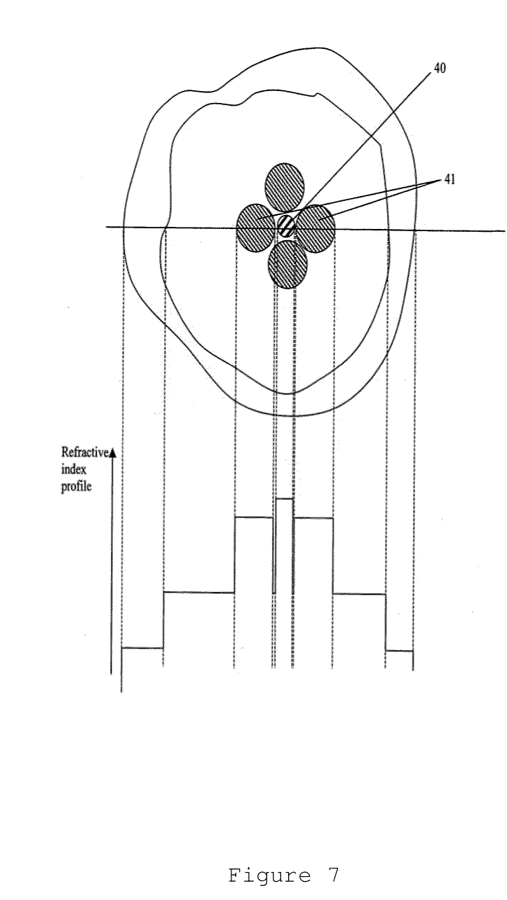

FIG. 7 is another diagram of a cross section of an embodiment of the current invention. In this example the inner core 40 is defined by a rod doped with one dopant and the outer core consists of a series of rods 41 which are doped with another dopant. The regions making up the outer core and the inner core must be in close proximity to allow optical communication of the light between the regions of 41 and the inner core 40. Thus the regions 41 and 40 define a single multimode light guide.

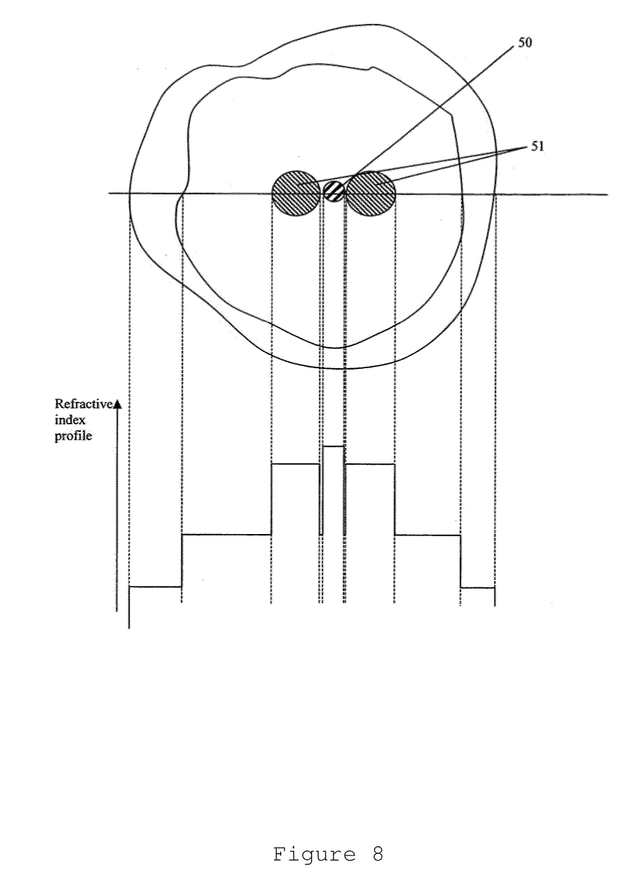

FIG. 8 is another diagram of a cross section of an embodiment of the current invention. This profile is similar to that of FIG. 7 but in this case there are only 2 regions 51 defining the outer core and the inner core 50. The regions of 51 can introduce a stress across the inner core 50 which creates birefringence which can be used to preserve the polarization of light travelling in the inner core 50.

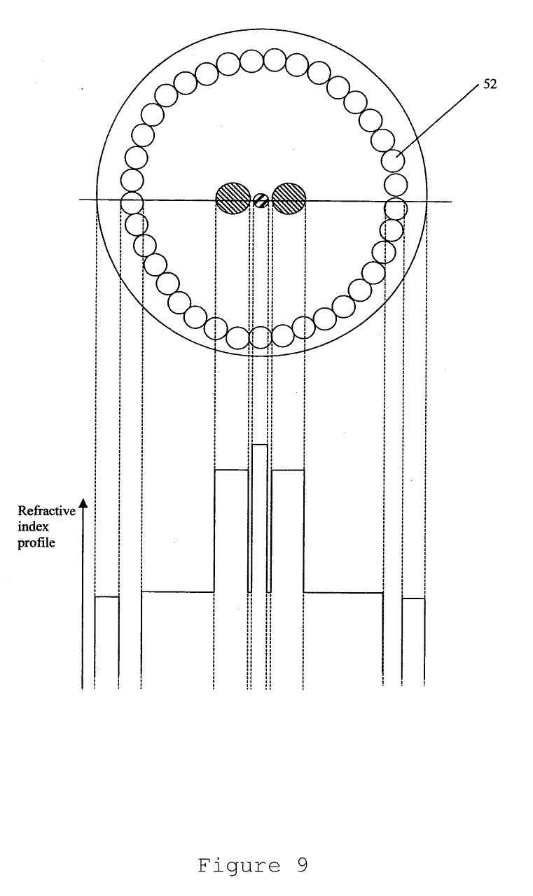

FIG. 9 is another diagram of a cross section of an embodiment of the current invention. This profile is similar to that of FIG. 8 but where a microstructure of air holes 52 is used to create a region of low refractive index which can be used as an outer cladding confining light within.

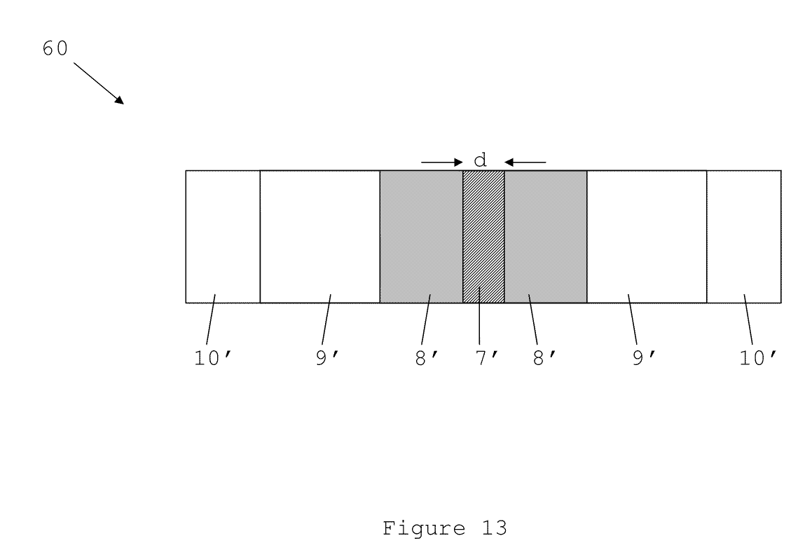

FIG. 13 shows a cross section of one embodiment of a planar waveguide within which the iterative brightness conversion takes place, analogous to the fiber embodiments described above, in which similar features are similarly numbered, and generally indicated by the numeral 60. The waveguide 60 has an inner-core light guiding region 7 having a laser active material such as holmium. The inner-core 7′ is of width d and may to operate in a single transverse and/or frequency mode. The waveguide has an outer-core light guiding region 8′ disposed about the inner-core 7′ having another laser-active material such as thulium. The outer-core 8′ is adapted to operate in a multimode manner. A cladding light guiding region 9′ is disposed about the outer-core 8′. The waveguide 60 has an outer cladding 10; disposed about the cladding light guiding region 9′ adapted to substantially continue light within it. In this embodiment the regions 7′, 8′ and 9′ are directly pumped by a diode bar emitting light at 790 nm, for example. The end faces of the waveguide have dielectric mirror-coatings to support laser action. In some embodiments, a relatively high aspect ratio of the waveguide devices (around 50 μm×5 mm) is convenient for pumping by close-coupling a linear array of diode laser pumps (or a laser diode bar) to the waveguide. The waveguide could be fabricated using microlithography, etching, and ion beam implantation of active dopants. Substrate materials include silicon, but many may be used as will be appreciated.

### Example

We report the first demonstration of resonant in-fiber pumping of the Ho³⁺ ion from one embodiment of a fiber laser having a double clad laser within a double clad laser. The fiber was designed to have a thulium outer core, and a holmium inner core. These dopants were selected in this first demonstration because Tm³⁺ displays efficient laser operation at ˜2 μm when pumped at 790 nm. This operating wavelength is close to the peak of the ⁵I₇ absorption band of Ho³⁺ which lases at 2.1 μm. To demonstrate the concept we employed an external resonator which was designed to be highly resonant at the thulium emission wavelength. The output coupler mirror was designed to outcouple a low percentage (˜20%) of the light produced from the Ho³⁺ laser transition.

The fiber was designed and fabricated at the Optical Fiber Technology Centre using MCVD and solution doping. The fiber preform was fabricated using a substrate tube which was placed in a glass working lathe and 12 layers of glass that were index matched to silica were deposited onto the inside surface of the tube. A silica flocculent layer was then deposited and solution doped with low concentration Tm³⁺ and Al³⁺ salts dissolved in ethanol. The Tm³⁺:Al³⁺ concentration ratio in the solution was 8:1. The doped flocculent layer was sintered forming a doped glass layer on the interior surface of the tube. This deposition-doping-sintering process was repeated twice forming a thick Tm³⁺-doped aluminosilicate layer. The final concentration of Tm³⁺ ions in this layer was deduced to be 2.1 wt. % by measuring the fiber absorption at 790 nm by a standard cut-back measurement (−9.1 dB/m), and measuring the area of the thulium annulus region as compared to the total area of the fiber. Eight thin germanosilicate layers were subsequently deposited in order to firmly separate the Tm³⁺-doped annulus region from the Ho³⁺-doped core. A final flocculent layer was deposited that was solution doped with a Ho³⁺, Al³⁺ and La³⁺ salt solution. The doped flocculent layer was finally sintered and the tube collapsed to form the preform. The Ho³⁺ concentration in the glass was estimated to be ˜0.4 wt. %. The Ho³⁺:La³⁺ concentration ratio in solution was 1:10. A large Al³⁺ concentration in the solution was implemented so that a significant refractive index difference between the core region and the surrounding layers was produced.

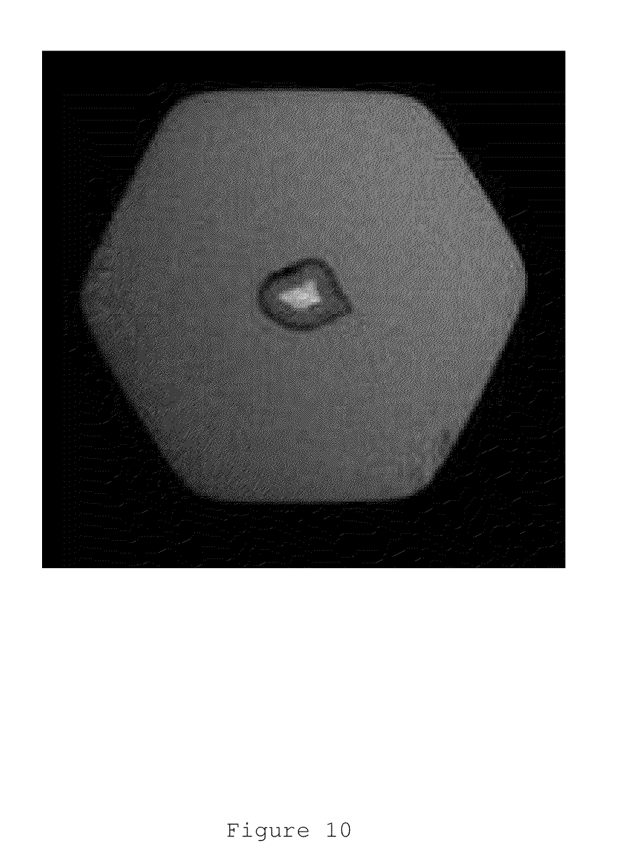

The preform was milled into a hexagon with a flat-to-flat separation of 274 μm. The final diameter of the Ho³⁺-doped core and outer diameter of the Tm³⁺-doped annulus were estimated from the refractive index profiles to be 12 μm and 23 μm respectively. The inside diameter of the Tm³⁺-doped annulus was difficult to measure accurately, but we have estimated the diameter to be 19 μm. The normalized V parameter of the Ho³⁺-doped core and Tm³⁺-doped annulus was ˜8 and ˜13, respectively. A photomicrograph of the fiber is shown in FIG. 10, which clearly shows the non-circular geometry which was a consequence of the many solution doping stages associated with the fabrication process. The outer cladding was removed in this cross-sectional view in order to allow the fiber to be efficiently cleaved.

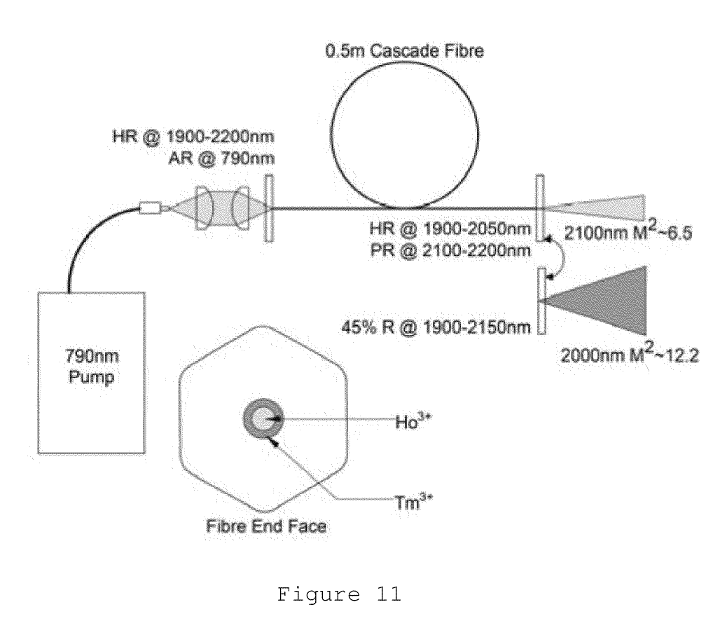

The experimental configuration used to demonstrate the fiber laser is shown in FIG. 11. The fiber laser was pumped with a 25% duty cycle fiber-coupled 790 nm 60 W pump source. The light from the pump was coupled into the fiber laser using bulk optical lenses which produced a non-optimized coupling efficiency of ˜51%. A broadly reflecting (HR@1.9-2.2 μm) mirror was butted against the fiber and we tested two output coupler mirrors to demonstrate operation of the fiber laser on either the thulium transition from the outer core or annulus (OC1: R=45%@1900-2150 nm) or the holmium transition from the inner core (OC2: HR@1900-2050 nm and R=80% at 2100 nm).

We measured the pump light absorption of the fiber to be quite strong therefore for the initial laser demonstration, we selected a fiber length of 50 cm which provided pump absorption of 65% compared to the launched pump power. For these experiments, the fiber was placed in a water bath, with the fiber ends held in copper V-groove mounts.

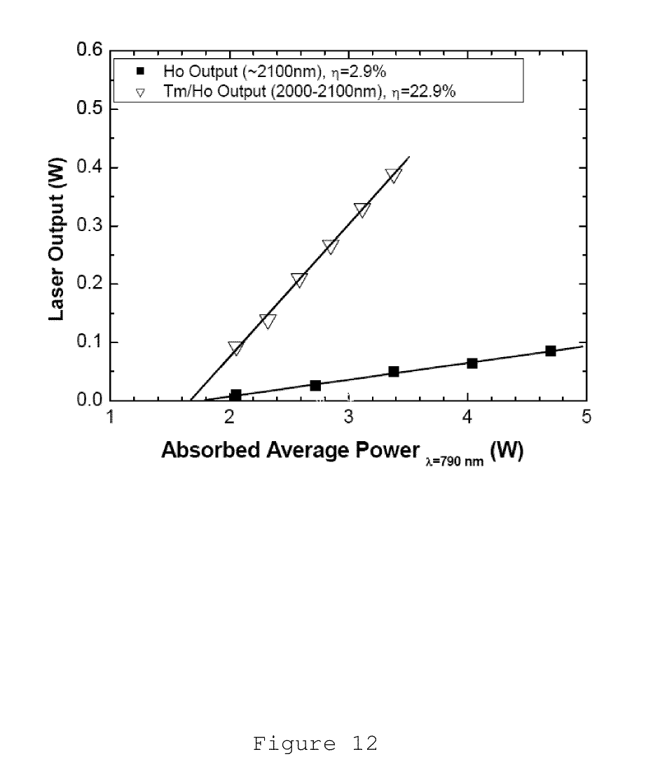

FIG. 12 displays the output characteristic of the cascade fiber laser for the two output couplers. When the output was provided by both transitions, i.e., when OC1 was employed, the slope efficiency was 23% and the maximum output power was 0.39 W (peak output power is 4×0.39 W due to the nominal 25% duty cycle of the pump laser). When the laser operated with the Ho³⁺ transition providing the output, the slope efficiency was 3% and the maximum output power was 86 mW (again peak power is ˜4 times higher). The spectral and spatial characteristics of the fiber laser output were highly dependent on the output coupler. For OC1, the spectrum was broad at low pump power (<2.5 W) centered at a wavelength ˜2012 nm. At higher pump power the spectrum broadened to also produce Ho³⁺ output near 2088 nm. We measured the beam quality of this output and it was found to have a low brightness as expected and M²_{x,y} of 11.9 and 13.5. For OC2, the wavelength of the output was measured to be a single peak at ˜2088 nm which is consistent with the holmium transition, and no evidence of laser operation at shorter wavelengths. The beam quality of the output under these conditions was significantly improved to produce an M²_{x,y} of 6.5 and 6.7. The results of the beam quality measurements are consistent with the normalized V parameters of the inner and outer cores discussed above.

The laser efficiency may be improved by optimizing the fiber laser length, and employing an output coupler with increased outcoupling of the holmium emission. Use of fiber Bragg gratings written directly into the germanosilicate layers may also enhance efficiency.

In the foregoing specification the terms light and optical have been used. It will be understood by one skilled in the art that this refers to electromagnetic radiation for which materials or fibers which guide the radiation can be fabricated. At present this extends from the far infrared to the ultraviolet potions of the spectrum but with the development of new materials it is possible fibers will be produced which transmit light out into other regions of the electromagnetic spectrum.

Although the invention has been herein shown and described as to what has been conceived to be the most practical and preferred embodiment, it is recognized that departures can be made in the scope of the invention, which is not to be limited to the details described herein but is to be accorded the widest scope so as to embrace any and all equivalent devices and apparatus.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An optical apparatus comprising:
an inner-core light guiding region having a laser active material, said inner-core being adapted to operate in a substantially single mode manner;
an outer-core light guiding region disposed about said inner-core having another laser active material, said outer-core being adapted to operate in a multimode manner;
a cladding light guiding region disposed about the said outer-core; and
an outer cladding disposed about said cladding light guiding region adapted to substantially confine light within said cladding light guiding region.

2. The optical apparatus defined by claim 1, where at least one laser active material in the inner-core is substantially pumped by light guided within the outer-core and where at least one laser active material of the outer-core is substantially pumped by light guided within the cladding.

3. The optical apparatus defined by claim 1 wherein one or more additional core light guiding regions are disposed iteratively about the said outer core each having a concentration of at least one laser active material, where the said cores are adapted to operate in a multimode manner.

4. The optical apparatus defined by claim 1 where the light guidance properties are defined by any one or a combination of material refractive index properties, effective refractive index formed by consequence of a microstructured design or through a bandgap effect by consequence of a microstructured design.

5. The apparatus defined by claim 1, further including stress elements or non symmetric shaped cores to induce birefringence.

6. The optical apparatus defined by claim 1 where multiple cores are contained within an outer core.

7. The optical apparatus defined by claim 1 where the materials used include silica, polymer or a non-silica glass including chalcogenide, fluoride or telluride.

8. The optical apparatus defined by claim 1 wherein the cladding or outer cladding or both are comprised of a polymer material.

9. The optical apparatus defined by claims 1, which has been spliced or otherwise optically coupled to one or more optical waveguides.

10. The optical apparatus defined by claim 1 wherein at least one additional optical fiber comprising a core is placed within optical communication with the cladding so that energy from the core can couple into the cladding of the optical apparatus.

11. The optical apparatus defined by claim 1 wherein a tapered fiber bundle, coupler, embedded mirror or V grooves is used to couple energy into the optical apparatus.

12. An amplifier incorporating the optical apparatus defined by claim 1.

13. A laser incorporating the optical apparatus defined by claim 1.

14. The optical apparatus defined by claim 12 wherein laser action occurs in the outer-core, by aid of optical feedback from the ends of the outer-core.

15. The optical apparatus defined by claim 12 wherein a grating is written into the inner-core so as to provide feedback in support of the lasing action or to double pass an amplifier.

16. An optical apparatus defined by claim 12 wherein dielectric coatings are placed on the ends in order to provide feedback in support of the laser action in at least one of the cores.

17. The optical apparatus defined by claim 1, wherein at least one laser active material is a rare earth element.

18. An optical apparatus defined by claim 1 comprising a planar optical waveguide.

19. An optical fiber comprising:
an inner core light guiding region having a laser active material, said inner core being adapted to operate in a substantially single mode manner;
an outer core light guiding region disposed about said inner core having another laser active material, said outer core being adapted to operate in a multimode manner, a cladding light guiding region disposed about said outer core; and
an outer cladding is disposed about said cladding light guiding region adapted to substantially confine pump light within said cladding light guiding region.

20. A method of generating radiation, the method comprising the step of:
coupling a light generated by a cladding pumped laser into a second waveguide in parallel with the cladding pumped laser, the light pumping a laser active material within the second waveguide.
